(19) United States
(12) Patent Application Publication
(10) Pub. No.: US 2003/0228520 A1
(43) Pub. Date: Dec. 11, 2003

(54) Process for manufacturing thermal battery with thin fiber separator

(76) Inventor: Thomas D. Kaun, New Lenox, IL (US)

Correspondence Address: Harry M. Levy, Emrich and Dithmar, 300 South Wacker Drive,, Suite 3000, Chicago, IL, 60606, US

(21) Appl. No.: 10/455,087

(22) Filed: Jun. 5, 2003

Related U.S. Application Data
(60) Provisional application No. 60/386,859, filed on Jun. 6, 2002.

(51) Int. Cl. H01M 2/16; H01M 4/58

(52) U.S. Cl. 429/247; 429/199; 429/221; 429/218.1; 429/220; 429/223

(57) ABSTRACT

A thin, fibrous ceramic article useful as a separator for a molten-salt thermal battery. A film of ceramic fiber and a bonding constituent that in processing enhances the strength flexibility and molten electrolyte retention of the film when used as a separator layer. The bonding constituent becomes a significant portion of the separator, such that the separator's chemical properties are a reflection of the binder. MgO is a preferred binder, but other electrically-insulating ceramics, e.g., AlN, are available. The ceramic fiber separator becomes a carrier element in a fabrication process, which allows the formation of dense electrode without the use of high-tonnage hydraulic presses.

### RELATED APPLICATIONS

This application, pursuant to 37 C.F.R. 1.78(c), claims priority based on provisional application serial No. 60/386,859 filed on Jun. 6, 2002.

This invention was developed with Navy SBIR funding under Contract no. Contract N00167-99-C-0071. The U.S. government may have certain rights in the invention.

### BACKGROUND OF THE INVENTION

The present invention relates to a unique material and method of making same which is useful as, among other things, a thin separator in thermal batteries. This thin separator material facilitates a continuous process to produce dense (50 vol % loading) electrode layers onto the separator layer a without high-tonnage hydraulic press.

The origin of articles of thin layers of ceramic fiber for separations at high temperature (greater than 300° C.) and extreme chemical activity (eg. Lithium and sulfur) are the production of BN fiber (Economy, U.S. Pat. No. 3,668,059) and formation of thin BN fiber mats (Hamilton, U.S. Pat. No. 4,284,610 and Maczuga, U.S. Pat. No. 4,354,986).

This material exhibited structural stability (compressive strength), small intertestices as particle barrier and could hold a large volume fraction (65-85%) of a working fluid, such as molten halide electrolyte. Because of its unacceptable high production cost (difficult high temperature fabrication), and difficulty in initiating wetting with molten halide, it was later abandoned for high-surface-area MgO powder. The MgO is a relatively cheap material, had chemical stability and could immobilize 65-85 Vol % of electrolyte. The drawback of MgO is limited structural stability and therefore limits on thinness. The MgO powder separator is a paste at the thermal cell operating temperature.

Attempts to make MgO fiber have resulted in a highly frangible product which is reduced to particles under compressive load application. Frankle U.S. Pat. No. 4,104,395 taught the impregnation of organic fibers with percursors to form mineral fibers after high temperature (1400° C.) processing. Smith, etal. U.S. Pat. No. 4,992,341 teaches production of fiber-like sheet of MgO. Threads of MgO powder in a combustible binder are layered into a sheet. Then, the “green” sheet is sintered to form a structure.

Due its frangible, formation of an MgO structure capable of compressive strength is limited to about 50% open volume fraction for a working fluid such as a molten halide electrolyte. This is taught in Briscoe etal. U.S. Pat. No. 5,714,283 in which an MgO structure is developed in conjunction with microporous sintered metal screen supports and the MgO sinter has in the range of 20-50% volume for electrolyte for a thickness of 3-25 mil. The low free volume imposes performance limitations, especially if there is structural disintegration.

Thermal batteries are the reserve power “of choice” on board many weapon and defense systems. Their outstanding quality is very long shelf life, about 25 years. They are essentially in a frozen state. Thermal batteries are activated using heat sources and within milliseconds they can produce very high pulse power. The power serves for guidance, communication, and arming of these systems. Accordingly, as a part of these systems, thermal batteries play a critical role in our national defense.

In thermal battery technology, the trend is toward higher power density. The design approach is for thinner cells. The battery itself is produced from pressed powder wafers: heat pellet, Li-alloy negative, MgO separator, and FeS₂ positive. Each wafer is about 1 mm thick. Battery performance would benefit from thinner MgO separators which physically and electrically separate anode from cathode. The separator is the ionic coupling between anode and cathode and should have high electrolyte content with connected porosity for high performance. Added features of dimensional stability and flexibility are desired separator characteristics. In one application, these wafer thin components limit battery pulse power to about 5.5 kW. A thinner MgO wafer would boost the proportion of active materials in the battery. The MgO powder wafer has limited handling strength. Thinner MgO may crack or break to destroy the entire batteries integrity. Larger diameter pieces exacerbate the handling problems. Additionally, the durability of the MgO powder wafer in operation requires a substantial thickness. Volumetric changes of the active material tend to distort the electrolyte/separator interface, which leads to cell shorting.

In one aspect, this invention relates to the design and manufacture of thermal batteries using a thin Ceramic Fiber Separator (CFS) as a substitute to the conventional pressed MgO powder separator can. The thinner CFS results in higher power (higher voltage and current) thermal batteries. A greater portion of the battery height is utilized to increase the number of cells (or voltage) in a battery. Less battery volume and thermal mass is inactive (as in the separator) such that significantly higher battery energy is developed. Pulse power may increase by 50%. Higher power density is a dominant theme in thermal battery development. In one application, the CFS may increase battery pulse power from 5.5 kW to about 8 kW.

The prevailing construction and chemistry of a state-of-the-art thermal battery has been around for about 25 years. It uses Li-alloy/metal sulfide electrodes and lithium halide salt. The salt becomes molten electrolyte upon thermal activation. The battery is composed of a stack of wafers of pelletized powders. Wafer fabrication and battery assembly involve substantial hand labor. The pressing operation has received some automation, but the battery assembly relies on hand stacking of components.

Current thermal battery manufacturing employs uniaxial powder pressing technology to form active cell components. Uniaxial powder pressing is limited in thickness, diameter, and overall geometry (parts are typically cylindrical). Thickness of uniaxially pressed parts range from approximately 1-10 mm. Production of thinner or thicker parts is notably difficult, commonly resulting in low yields and therefore, higher labor costs. Thinner parts require precise, even die loading while thicker parts require the use of organic binders to distribute the applied pressure evenly. Similarly, large diameter parts are difficult to uniaxially press due to increasingly larger processing equipment required to provide the necessary mechanical loads effectively to form the powders (typically >10,000 psi). These limitations preclude many advanced battery designs.

For electrode pellet manufacture, the high tonnage press is typically required to achieve 50 volume % active material loading having a portion of electrolyte salt present to form cold-pressed pellets. The metal sulfide electrode material, FeS₂ (also used as brake lining material), is a very hard material and does not compact on its own. For example, the pressed electrode uses FeS₂ coated with electrolyte salt to facilitate the powder compaction. The resultant cold-pressed pellet would have 50 volume % FeS₂, 30 volume % electrolyte salt and 20 volume % void. An unpressed powder layer would typically have 50 volume % void. To achieve the desired 50 volume % active material loading, the high tonnage press must displace 30 volume % void that is needed for the electrolyte salt. This is crucial, in that unpressed electrodes with 20-30 volume % loading have poor performance—low energy density and low power.

Separator material in previous development of molten salt battery was MgO high-surface area powder, such a Maglite S or Maglite D (Calgon), and more recently Marinco OL (Marine Magnesium Company). These materials mixed with electrolyte salt have been the materials of choice for pressed powder separators. Alternative materials, Boron long-life rechargeable molten salt battery. Only the pressed-powder MgO/salt separator has found commercial application. Both alternatives have proven too costly by comparison and both have physical properties that have hindered design, production, or operation of thermal batteries.

This invention when used as a CFS for thermal battery separators has unique chemical stability to Li activity and wetability to molten halides. In addition, the CFS has excellent handling characteristics (flexure strength) and durability in molten salt. As a ceramic film compared to an MgO particle bed, the thin CFS withstands distortion from the volume changes in cell capacity discharge. Additionally, CFS provides the foundation for a new, more-economic manufacture of thermal batteries. The structural stability of CFS in molten salt permits electrode to be applied to itself in a continuous process. Further, the ability to manipulate large diameter, thin CFS enables new designs for a high power thermal battery. Experiments have shown the ability of CFS to increase battery power and energy density.

### SUMMARY OF THE INVENTION

The principal object of the present invention is to provide a thin and flexible fibrous ceramic article useful as a filter or separator in a molten salt thermal battery.

Another object of the present invention is to provide a separator for a thermal battery, comprising a porous film of electrically non-conductive ceramic fibers and electrically non-conductive ceramic binder, the ceramic fibers being present in the range of from about 70% to about 90% by weight, the ceramic binder being present in the range of from about 10% to about 30% by weight, the film having a porosity of not less than about 50% by volume.

Yet another object of the present invention is to provide a separator and electrolyte combination for a thermal battery, comprising a porous film of electrically non-conductive ceramic fibers and electrically non-conductive ceramic binder, the ceramic fibers being present in the range of from about 70% to about 90% by weight, the ceramic binder being present in the range of from about 10% to about 30% by weight, and an alkali metal halide electrolyte present in the porous film up to about 95% by volume of the combination.

Yet another object of the present invention is to provide a cell comprising a lithium-containing anode and a powder cathode separated by a thin film less than about 12 mils in thickness of electrically non-conductive ceramic fibers and electrically non-conductive ceramic binder, the ceramic fibers being present in the range of from about 70% to about 90% by weight, the ceramic binder being present in the range of from about 10% to about 30% by weight, and an alkali metal halide electrolyte present in the thin film up to about 95% by volume.

Yet another object of the present invention is to provide a method of making a ceramic combination, comprising providing a suspension of ceramic fibers, filtering the suspension of ceramic fibers leaving a mat of ceramic fibers, introducing a ceramic binder or precursor thereof into the mat of ceramic fibers, drying the ceramic fibers and ceramic binder or precursor thereof, and heating at a temperature and for a time sufficient to convert the precursor of the ceramic binder if present to the binder to provide a ceramic of fibers and binder having a porosity not less than about 50% by volume.

Yet another object of the present invention is to provide a more economical manufacture of thermal batteries. Integration of ceramic fiber separator with a electrode particle bed is accomplished by molten salt infiltration. The resulting component containing a dense electrode (50 vol % active material) has improved handling for thin-cell battery production.

A final object of the present invention is to provide a continuous manufacturing method for thermal battery cells in which handleable electrode of 40-60% active material is produced without the conventional high tonnage hydraulic press. A thermal process integrates a ceramic fiber separator with a bed of electrode (active material) particles. The ceramic fiber separator, CFS, enables the electrolyte to infiltrate metal-sulfide, particle-bed and retain the initial particle-bed density of 50 volume %. The CFS has structural integrity; so as the electrolyte salt melts, the CFS regulates the flow of the salt over to the electrode powder bed to keep from fluidizing.

Additional advantages, objects and novel feature of the invention will become apparent to those skilled in the art upon examination of the following and by practice of the invention.

### BRIEF DESCRIPTION OF THE DRAWINGS

FIG. 1 depicts in cross-section, the process for making a laminate of Ceramic Fiber Separator (CFS) along with a pressed-powder FeS₂/electrolyte electrode;

FIG. 2 depicts the conveyor belt (a) process for making a laminate cross-section b-f of Ceramic Fiber Separator (CFS) along with a metal-sulfide, particle-bed, which after electrolyte addition becomes an electrode;

FIG. 3 is a graph of the Modulus of Rupture in psi for a Ceramic Fiber Paper/electrolyte and the standard MgO/electrolyte Pressed Pellet;

FIG. 4 is a cell voltage/time plot of LiSi/COS₂ cell having CFS with 10 sec pulses at 0.9A/cm²;

FIG. 5 is a graph illustration comparing the final voltage of 10 second pulses at 0.9A/cm² current density for the direct substitution of 10 mil CFS for 10 mil pressed MgO powder separator; and

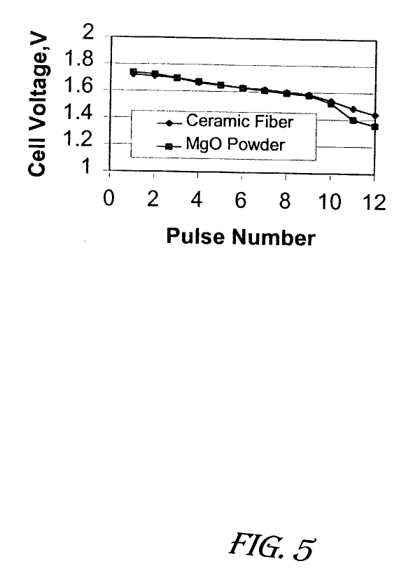

FIG. 6 is a graph illustrating the low impedance of LiSi/CoS2 cell with 10 mil CFS, based on 10-sec pulses of 0.9A/cm².

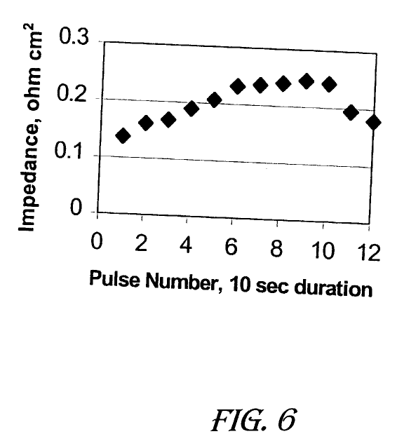

### DETAILED DESCRIPTION OF THE INVENTION

This invention relates to ceramic articles and methods of making same which are electric insulators useful for a variety of purposes. However, for illustration purposes, the invention will be described in connection with a thermal battery. A CFS separator that consists of 10/90 to about 30/70 weight ratio of ceramic fiber/ceramic binder is a preferred embodiment for a thermal battery. Fiber diameter is about 10 microns and fiber length is about 1000 microns. Objective to form a separator for thermal battery consisting of resilient ceramic fiber formed into a film of 3-12 mil thickness that allows at least 85% electrolyte volume to impart high ionic conductivity. A most preferred separator composition is 56% A1₂O₃ fiber, 19% AlSiO₂ fiber, 25% MgO binder, by weight. An example of the fiber blend is 75/25 weight % A1₂O₃/AlSiO₂. Fiber sources are Altra Al₂O₃ from Rath (Wilmington, Del.) and Fiberfrax AlSiO₂ from Carborundum. The MgO binder constituent after “firing” has a 30% weight contribution. SiO₂ or ceramic/glasses with higher levels of SiO₂ have been fund to be of insufficient chemical stability for the high Li-activity Li-alloy electrodes that are generally used in thermal batteries. Other fibers may be sulfide ceramics such as CaAl₂S₄, YALS₃, LiAlS₃ or AlN. Our use of a binder that decomposes into MgO further enhances the chemical stability of the separator. Other candidate binders are aluminum nitrate, aluminum acetate and other like organometallic compounds available through from Sigma-Aldrich Co. As a replacement for MgO powder, the film separator with MgO binder possesses durability and flexibility. After the fiber is “dropped” onto a fine polyester mesh for a 3 mg/cm² to a given 130 micron thick layer, a series dry/infiltrate steps coats and connects the interstices of the fiber mat with Mg Acetate from Sigma-Aldrich (Milwaukee, Wis.). (Dropping refers to a papermaking process in which the fiber is collected on a fine screen as the aqueous suspension of fiber rushes through the fine screen). The Mg Acetate is applied as a 0.6 g/cc aqueous solution about two and a half times (as explained in the subsequent procedure). Mg carbonate or Mg hydroxide are other soluble magnesium compounds which could be substituted for Mg acetate. Addition of isopropyl alcohol or the like to the aqueous Mg acetate solution helps wet the ceramic fiber and enhance the drying. Drying is done in flowing air at about 75-100° C. After drying about 2 hours, the ceramic fiber paper CFS can be peeled from the fine polyester mesh. (Use of a combustible carrier is a good option to the peeling step.) The CFS is sufficiently rigid for good cutting and use of die punch; yet it can be picked up having sufficient flexure strength that it doesn't easily crack and break apart. CFS as thin as 100 micron can be handled in sheets as large as 250 mm diameter. The ceramic film has been made using the following procedure:

1. Fiber blending with water in impeller.

2. Fiber dispersion into water.

3. Release trap door on bottom of tank.

4. Collect fiber mat onto fine mesh (polyester vale).

5. Drip dry.

6. Damp mat is infiltrated with aqueous solution containing binder.

7. Completely dry in flowing hot-air drier.

8. Repeat binder infiltration.

9. Repeat drying in hot-air drier.

10. Peel fiber paper from fine mesh fabric.

11. Cut to desired size.

12. Process at 600-650° C. in air for 3-6 hours.

Other methods useful for making the ceramic composition of this invention are as follows:

1. A vacuum roller pulls fiber from a fluidized bath containing ceramic fiber onto a belt (e.g. fine mesh screen or combustible carrier).

2. Ceramic fiber in an aqueous suspension is sprayed onto a belt (e.g. fine mesh screen or combustible carrier).

3. Ceramic fiber in gelatinous medium is slip cast onto a belt (e.g. fine mesh screen or combustible carrier).

4. Ceramic fiber in an air dispersion is blow onto a belt (e.g. fine mesh screen or combustible screen).

The present invention provides Ceramic Fiber Separator (CFS) at 4-12 mil thick to overcome the present thinnest limits of 25 mil for cell pressed wafers at 10 mm diameter or larger. Because it is also supplied in the form of a flexible sheet, CFS offers cost saving options for thermal battery manufacture. The cost of conventional thin-cell thermal batteries is inflated by the poor handling of the wafer-thin components. A thirty percent parts loss rate is presently typical. Even at the conventional thicknesses, the battery would benefit from applying CFS. The fragility of the wafer pellets has required expensive hand assembly. The durability of CFS (it is bendable and passes a “drop” test) permits automated, faster assembly. Withdrawal of human error from the assembly process, improves quality control, thereby further increasing the profitability for thin-cell thermals. Wetting with molten halide, bending strength, flexibility, small pore-size, low density, tortuosity are properties required for an improved separator of a thin-cell, high-power thermal battery. This combustion enables significant cost reduction and improved quality control for the production of thin-cell thermal batteries.

CFS provides superior thinness and strength to increase battery power and energy density. For larger sizes (>3 in. diameter), handling difficulty prohibited thin-cell battery construction and/or caused significantly increased cost.

Cell Fabrication with CFS.

The structural stability of CFS in the presence of molten salt becomes the basis for an improved method for thermal cell manufacture. In this thermal battery manufacture, CFS serves as a buffer to limit molten electrolyte to metal-sulfide, particle-bed electrode. Too much electrolyte would fluidize the particle bed; thus destroying the packing-density and the physical dimensioning of the wafer-thin electrode. The CFS is used in three variations of cell manufacture which results in the fabrication of a CFS/metal-sulfide electrode laminate. The laminate significantly enhances the handling strength of a separator/electrode component and also gives insurance of components mating and being flat for stacking. The form of the metal-sulfide electrode dictates the fabrication procedure. The conventional metal-sulfide electrode is a pressed powder bed of metal-sulfides and electrolyte salt. The other two approaches do not contain electrolyte salt; they are a simple particle bed contained within a cup, or a typecast layer that is particle bed contained by an expendable binder matrix. The process enables the electrolyte to infiltrate these metal-sulfide, particle-bed matrices and retain the initial particle-bed density of 50 volume %. In prior art, production of metal-sulfide electrode pellet with particle-bed density that approached 50 vol % would require high-tonnage hydraulic presses. The salt component of the pellet was compacted between the metal-sulfide particles by the elimination of void volume. The present invention infiltrates molten salt in a controlled fashion into a particle-bed can achieve the same particle-bed density, 50 vol %, without the high-tonnage hydraulic presses.

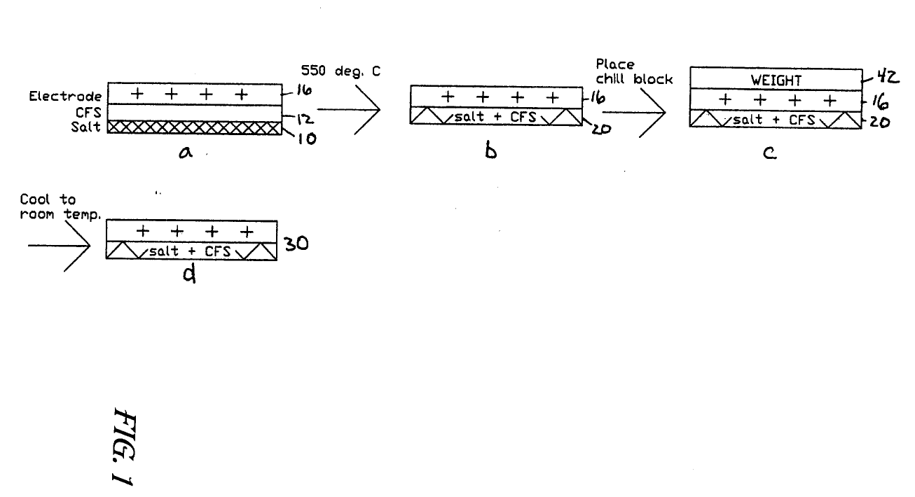

The cross-sectional views FIGS. 1(a)-(d) depicts the process for making a laminate of Ceramic Fiber Separator (CFS) along with a pressed-powder FeS₂/electrolyte electrode. The laminated component 30 enables thin, large-diameter separator and cathode to be assembled into a thermal battery. In FIG. 1a, the first step on conveyor through a tunnel furnace is an amount of electrolyte powder 10 is placed onto the conveyor. This is the amount necessary to infiltrate the CFS. It can be dispensed by a shoe (a powder filled hopper) traveling over a cavity (not shown) or a die punched, piece of tapecasted electrolyte powder. The CFS piece 12 is placed onto electrolyte powder 10. In turn, the pressed powder FeS₂/electrolyte electrode 16 is placed onto the CFS piece 12. The stacked components then travel through a tunnel furnace at 550° C. for 2 minutes. As in FIG. 1b, the electrolyte powder 10 is melted and infiltrated into CFS piece 12 to form CFS/electrolyte salt 20. The pressed-powder FeS₂/electrolyte electrode 16 remains on top. The stacked components then travel out the tunnel furnace, where as in FIG. 1c, a copper chill block 42 is put in place. After cooling to room temperature in 2 minutes, FIG. 1d, the laminated CFS/cathode 30 emerges. The frozen electrolyte salt unitizes the layers for superior handling. The laminated CFS/cathode 30 (along with anode, heat pellet and current-collector sheet, (now shown) is immediately available for assembly of a thermal battery.

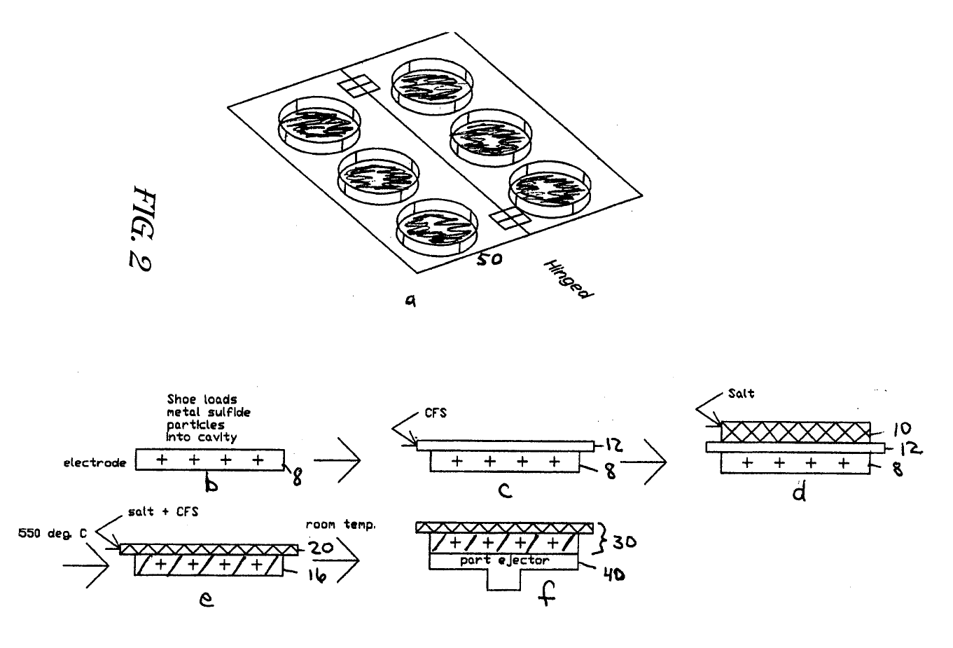

The cross-sectional view of FIGS. 2(a)-(f) depict the process for making a laminate of ceramic fiber separator (CFS) along with a FeS₂ powder bed (in essence eliminating the hydraulic pressing step). The laminated component 30 enables thin, large diameter separator and cathode to be assembled into a thermal battery. As in FIG. 2a, the process uses a conveyor belt 50 that consists of plates with shallow cups. In FIG. 2b, the first step on conveyor through a tunnel furnace is an amount of metal sulfide powder 8 is placed onto the conveyor. It can be dispensed by a shoe (a powder filled hopper) traveling over a cavity (not sown) or a die punched, piece of tapecasted electrode powder. In FIG. 2c, the CFS piece 12 is placed onto electrode powder 8. In turn, FIG. 2d, the electrolyte powder 10 is placed onto the CFS piece 12. This is the amount of electrolyte powder 10 necessary to infiltrate both the CFS 12 and the FeS₂ powder bed 8. Again, the electrolyte powder can be dispensed by a shoe (a powder filled hopper) traveling over a cavity (not shown) or a die punched, piece of tapecasted electrolyte powder. The stacked components then travel through the tunnel furnace at 550° C., 2 minutes. As in FIG. 2e, the electrolyte powder 10 is melted and infiltrated into CFS to form piece 20 and the FeS₂ cathode 16 with molten electrolyte salt. The stacked components then travel through the tunnel furnace at 550° C., 2 minutes. The stacked components then travel out the tunnel furnace, where after cooling to room temperature in 2 minutes as in FIG. 2f, the laminated CFS/cathode 30 emerges. Laminated part 30 is ejected from the cavity by part-ejector 40 (a push plate) that is at the bottom of each cup on the conveyor. The frozen electrolyte salt along with the high Modulus of Rupture (MOR) of the CFS unitizes the layers for superior handling. The laminated CFS cathode 30 (along with anode, heat pellet and current-collector sheet, not shown) is immediately available for assembly of a thermal battery.

The preferred fiber for the CFS is about 10μ diameter and about 1 mm long. Ceramic fibers are generally manufactured to a nominal fiber diameter of between 3-4μ (micrometers), although a typical range of actual diameters is 0.2-8.0μ.

Below are manufacturers/supplier trade name/form of material.

Carborundum/Fiberfrax/Bulk loose, Felt, and paper, Rope and braid.

Morganite/Triton Kaowool/Bulk loose, Blanket, Felt and paper.

Bells Thermalag/Kaowool/Pyrotek M6 felt.

ICI/Saffil/Saffil bulk A1₂O₃ fiber.

Manville/Cerafiber/Cerawool.

Rath/Altra/bulk A1₂O₃ fiber.

Rath/HTZ/bulk AlSiO₂ fiber.

### EXAMPLES

### Example 1

Production of a CFS Part.

A CFS composition of 75/25 weight % A1₂O₃/AlSiO₂ fiber (e.g. Saffil by ICI/Fiberfrax by Carborundum) is prepared by using a blender to suspend 3.0 g fiber in 0.5 liter water. In a papermaking machine, the fiber is dispersed in 8 liters of water. After the fiber is “dropped” onto a fine polyester mesh for a 6 mg/cm² loading to give a 250 micron thick layer of 250 mm diameter, a series dry/infiltrate steps coats and connects the interstices of the fiber mat with Mg acetate. The Mg acetate is applied as a 0.6 g/cc aqueous solution about two and a half times (as explained earlier, the first application is done with the fiber mat not totally dry). Addition of 5 vol % isopropyl alcohol to the aqueous Mg acetate solution helps wet the ceramic fiber and enhance the drying. Drying is done in flowing air at about 75-100° C. After drying about 2 hours, the ceramic fiber paper CFS can be peeled from the fine polyester mesh. The pieces of CFS are cut to desired size using Exacto knife and precision form, such as 2.05″ diameter. The CFS piece is processed at 600-650° C. in air for 3-6 hours to convert the Mg acetate is MgO. Electrolyte is infiltrated into the CFS by placing a weighed amount of electrolyte powder onto the CFS, placing it onto 500° C. hot plate, just long enough to melt the electrolyte. The electrolyte-infiltrated piece is placed onto chill-block (e.g. a Mo plate) and cooled under a weight. This separator piece is then stacked between pressed-pellets of LiSi/electrolyte and CoS₂/electrolyte to form a test cell.

An important specification related to the handling strength of separators is the Modulus of Rupture (MOR) or bending strength before breaking. As the separator is thinned, it becomes easier to break. A three-point break apparatus is used to evaluate modulus of rupture (MOR). The MOR is determined by incrementally-loading the three-point fixture (usually three rods in parallel) until the specimen snaps. Separator MOR values are determined from a group of repeated tests. The MOR is normalized for varying cross-section.

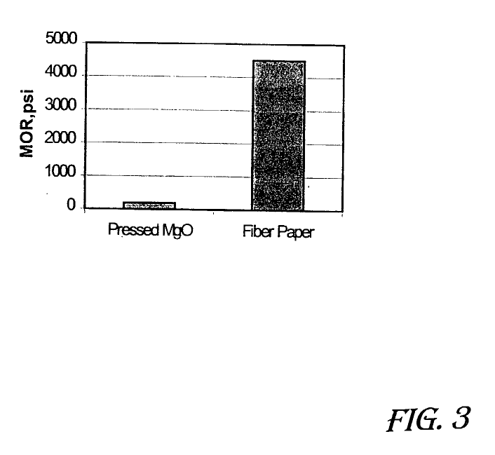

The CFS has an MOR of 2,000 up to 4,500 compared to only about 100 for the conventional pressed powder MgO/salt pellet, as illustrated in FIG. 3 and this is what is meant by use of the term “flexible” regarding the ceramic articles of the present invention. Since the bending moment increases for a larger diameter separator, the MOR becomes more critical. The MOR for CFS is 20 times greater than that of the MgO powder separator, or it has the same handling strength at 5% the thickness of the MgO separator. It is therefore understandable that the CFS at 50% thickness of the MgO separator thickness has superior handling strength. It is therefore understandable that the CFS at 50% thickness has superior handling strength, and also fulfills the targeted power density of the emerging thermal battery market. Additionally, the ceramic material of this invention when used as separators in a cell have the chemical and physical properties necessary to meet the high current density at high power. These are 85-95% open volume (high electrolyte content) and the chemical stability to provide resistance to Li corrosion. Unlike pressed MgO powder separator, full-size 3.66″ diameter CFS separators pass the “drop test”, and display physical flexibility even after electrolyte filling. The CFS can reduce cell thickness and weight, due to a lowered piece-loss rate. Approximately 15% more cells may be added to a battery by substituting CFS for pressed, MgO powder separator.

### Example 2

CFS Laminated with Pressed Electrode Pellet.

A CFS composition of 75/25 weight % A1₂O₃/AlSiO₂ fiber (e.g. Altra Al₂O₃ from Rath (Wilmington, Del.)/Z-90 SAZ P-15 AlSiO₂ fiber from K Industrial (Livonia Mich.) is prepared by using a blender to suspend 1.5 g fiber in 0.5 liter water. In a papermaking machine, the fiber is dispersed in 8 liters of water. After the fiber is “dropped” onto a fine polyester mesh for a 6 mg/cm² loading to give 250 micron thick layer of 250 mm diameter, a series dry/infiltrate steps coats and connects the interstices of the fiber mat with Mg acetate. The Mg acetate is applied as a 0.6 g/cc aqueous solution about two and a half times (as explained earlier, the first application is done with the fiber mat not totally dry). Addition of 5 vol. % isopropyl alcohol to the aqueous Mg acetate solution helps wet the ceramic fiber and enhance the drying. Drying is done in flowing air at about 75-100° C. After drying about 2 hours, the ceramic fiber paper CFS can be peeled from the fine polyester mesh. The pieces of CFS are cut to desired size using an Exacto knife and precision form, such as 2.05″ diameter. The CFS piece is processed at 600-650° C. in air for 3-6 hours to convert the Mg acetate is MgO for a 70/30 weight ratio of ceramic fiber/MgO binder. This separator piece is then stacked with COS₂/electrolyte pressed-pellet as in FIG. 1. Electrolyte is infiltrated into the CFS by placing a weighed amount of LiCl—LiBr—KBr electrolyte powder, 1.28 g, onto a 500° C. hot late, just long enough to melt the electrolyte into the CFS. The electrolyte-infiltrated CFS piece becomes laminated to the CoS₂/electrolyte pressed-pellet and is placed onto chill block (e.g. a Mo plate) and cooled under a weight. The electrolyte/separator weight ratio is 87/13. A LiSi/electrolyte pressed-pellet is stacked with the CFS/CoS₂ electrode pellet laminate to form a test cell.

### Test Results for Example 2

This film ceramic fiber separator (CFS) is produced at less than about 12 mils and preferably at 4-6 mil thickness. Electrolyte infiltration and handling are improved.

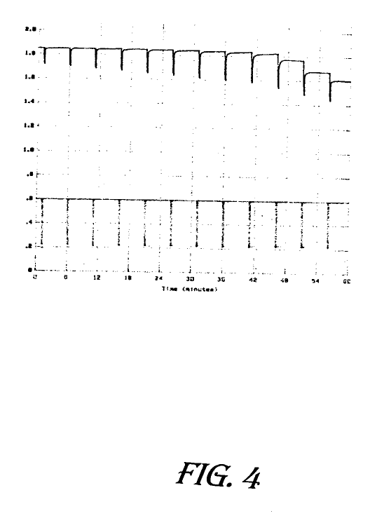

The CFS was tested under state thermal conditions using the LiSi/CoS₂ couple with molten halide electrolyte. LiSi/COS₂ cells having CFS were tested with 10 second pulses using 0.9 Acm² current density at 500° C., see FIG. 4. Outstanding performance of greater than 1.6 volts for the pulse voltage for the first 75% of cell capacity showed that CFS could meet or exceed the performance of the pressed MgO powder separator.

### Example 3

CFS Laminated with Electrode Particle Bed

CFS with an electrode from a powder bed are introduced into a cup (no hydraulic pressing of a pellet) to form a laminate. A CFS composition of 70/30 weight % Al₂O₃/AlSiO₂ fiber is formed as in Example 1 with a 75/25 weight ratio of ceramic fiber/MgO binder. As in FIG. 2, the 250 micron thick CFS is positioned onto the cavity that has been filled with FeS₂ particles. The cavity is coated with BN to eliminate sticking to the cup. In this procedure, the LiCl—LiBr—KBr electrolyte addition, 2,3 g, also includes the portion for the electrode infiltration. The arrangement of materials is then passed through a 550° C. tunnel furnace. After the electrolyte melts and infiltrates the two component layers, the electrolyte/separator weight ratio is 87/13 and the electrolyte/FeS₂ cathode weight ratio is 25/75. The electrolyte-infiltrated CFS piece becomes laminated to the FeS₂/electrolyte pellet. The laminated component possessing superior handling strength is available for battery stack assembly.

### Example 4

CFS Laminated with Tapecast Electrode Particle Bed

CFS with electrode from tapecast, cathode material powder bed to form a laminate. The tapecast electrode is comprised of particles held together in 2-5 vol % polymer matrix. The polymer matrix is a handling method for the electrode particle bed; it is removed in the thermal processing.

A CFS composition of 80/20 weight % Al₂O₃/AlSiO₂ fiber is formed as in Example 2 with a 80/20 weight ratio of ceramic fiber/MgO binder. As in FIG. 2, the 125 micron thick CFS is positioned onto the typecast sheet of cathode, a powder bed of FeS₂—CuFeS₂ particles (50 vol. % FeS₂—CuFeS₂ particles). The pieces of CFS laminated with tapecast cathode are cut to desired size using Exacto knife and precision form, such as 2.05″ diameter. The conveyor belt is coated with BN to eliminate sticking. In this procedure, the LiCl—LiBr—KBr electrolyte addition, 2,3 g, also includes the portion for the electrode infiltration. The arrangement of materials is then passed through a 550° C. tunnel furnace. After the electrolyte melts and infiltrates the two component layers, the electrolyte/separator weight ratio is 89/11 and the electrolyte/cathode weight ratio is 22/78. The electrolyte-infiltrated CFS piece becomes laminated to the cathode/electrolyte pellet. The laminated CFS/cathode component (possessing superior handling strength) stacked with LiSi/electrolyte pellet is available for battery stack operation.

Ceramic materials of the present invention
have the following proprties:

| | |
|---|---|
| MOR of Salt-Loaded Parts | >2000 psi |
| Average bulk density (without electrolytes) | 0.3 g/cm³ |
| Open Volume | 90-95% |
| Thickness | 0.003-0.25″ |
| Tensile Strength | >350 g/in |
| Maximum Use Temperature | 1200° C. |

TABLE 1
12/21 Separator Comparison

| Characteristics | MgO Powder Pellet | Ceramic Fiber Film Separator |
|---|---|---|
| Thickness | 10-25 mil | 5-10 mil |
| Cost, % of Total | 3% | 10% of Thin Cell Materials |
| Size Limitation | 3.5 in Diameter | Up to 10 in Diameter |
| | | achieved |
| Handling | Brittle | Flexture |
| Electrolyte Content | 70 vol. % | 85 vol. % |

While there has been disclosed what is considered to be the preferred embodiment of the present intention, it is understood that various changes in the details may be made without departing from the spirit, or sacrificing any of the advantages of the present invention.

I claim:

1. A separator for a thermal battery, comprising a porous film of electrically non-conductive ceramic fibers and electrically non-conductive ceramic binder, said ceramic fibers being present in the range of from about 50% to about 95% by weight, said ceramic binder being present in the range of from about 5% to about 50% by weight, said film having a porosity of not less than about 50% by volume.

2. The separator of claim 1, wherein said ceramic fibers are up to about 10 microns in diameter and about 1 mm in length.

3. The separator of claim 1, wherein said ceramic fibers are oxides.

4. The separator of claim 1, wherein said ceramic fibers are Al₂O₃, AlSiO₂, BN, AlN, sulfide ceramics or mixtures thereof.

5. The separator of claim 4, wherein Al₂O₃ is present as a fiber in the range of from about 50% to about 95% by wt and AlSiO₂ is present as a fiber in the range of from about 5% to about 50% by wt.

6. The separator of claim 1, wherein said binder contains a compound of Al, Mg, S or mixtures thereof.

7. The separator of claim 1, wherein said binder is an oxide, nitride, sulfide or mixtures thereof.

8. The separator of claim 7, wherein MgO is present in said binder.

9. The separator of claim 7, wherein AlN₃ is present in said binder.

10. The separator of claim 7, wherein a sulfide of CaAl₂S₄, YALS₃, LiAlS₃ or mixtures thereof is present in said binder.

11. The separator of claim 1, wherein said film is flexible.

12. The separator of claim 1, wherein said film has a thickness of less than about 12 mils.

13. The separator of claim 1, wherein said film has a thickness in the range of from about 5 to about 10 mils.

14. The separator of claim 13, wherein said porous film has pores up to about 5 microns in average diameter.

15. The separator of claim 14, wherein the separator fiber is about 56% by weight Al₂O₃ and about 19% by weight AlSiO₂ and the binder is MgO present about 25% by weight.

16. A separator and electrolyte combination for a thermal battery, comprising a porous film of electrically non-conductive ceramic fibers and electrically non-conductive ceramic binder,said ceramic fibers being present in the range of from about 50% to about 95% by weight, said ceramic binder being present in the range of from about 5% to about 50% by weight, and an alkali metal halide electrolyte present in said porous film up to about 95% by volume of the combination.

17. The combination of claim 16, wherein Al₂O₃ is present in said ceramic fibers and the combination has a thickness less than about 12 mils.

18. The combination of claim 17, wherein the alkali metal halide includes a salt of lithium.

19. The combination of claim 18, wherein the alkali metal halide is a mixture if LiCl—LiBr—KBr.

20. The combination of claim 16, wherein the volume ratio of the electrolyte to the separator is at least 80 to 20.

21. The combination of claim 20, wherein the ceramic fibers are Al₂O₃, AlSiO₂ or mixtures thereof, and the binder includes a compound of Al, Mg, B, S or mixtures thereof and the film is flexible.

22. A combination electrode and separator film with electrolyte therein, comprising a porous film of electrically non-conductive ceramic fibers and electrically non-conductive ceramic binder, said ceramic fibers present in the range of from about 50% to about 95% by weight, said ceramic binder present in the range of from about 5% to about 50% by weight, an alkali metal halide electrolyte present in said porous film up to about 95% by volume of the porous film, and a cathode material at 50 volume % of the electrode adhered to the separator film and electrolyte.

23. The combination of claim 22, wherein the cathode material includes a compound of one or more of Fe, Co, Cu and Ni.

24. The combination of claim 23, wherein the separator film contains fibers of Al₂O₃ and is less than about 12 mils thick having an electrolyte containing LiCl present in an amount in the range of from about 80% to about 95% by volume of the porous film.

25. A cell comprising a lithium-containing anode and a powder cathode separated by a thin film less than about 12 mils in thickness of electrically non-conductive ceramic fibers and electrically non-conductive ceramic binder, said ceramic fibers being present in the range of from about 50% to about 95% by weight, said ceramic binder being present in the range of from about 5% to about 50% by weight, and an alkali metal halide electrolyte present in said thin film up to about 95% by volume.

26. The cell of claim 25 wherein the cathode material includes a compound of one or more of Fe, Co, Cu and Ni, the thin film contains fibers of Al₂O₃ and an electrolyte containing LiCl is present in the thin film amount in the range of from about 80% to about 95% by volume of the film, and the anode contains Li or a compound thereof.

27. A battery including a plurality of the cells of claim 26, connected in series or parallel.

28. A ceramic article comprising a porous film of a combination of ceramic fibers and a ceramic binder, said ceramic fibers being present in the range of from about 50% to about 95% by weight, said ceramic binder being present in the range of from about 5% to about 50% by weight, said film having a porosity of not less than about 50% by volume.

29. A method of making a ceramic combination, comprising providing a suspension of ceramic fibers, filtering the suspension of ceramic fibers leaving a mat of ceramic fibers, introducing a ceramic binder or precursor thereof into the mat of ceramic fibers, drying the ceramic fibers and ceramic binder or precursor thereof, and heating at a temperature and for a time sufficient to convert the precursor of the ceramic binder if present to the binder to provide a combination of ceramic fibers and binder having a porosity not less than about 50% by volume.

30. The method of claim 29, wherein the ceramic fibers are one or more of Al₂O₃, AlSiO₂, BN, AlN, and the ceramic binder is a compound of one or more of Al, Mg, S.

31. The method of claim 29, wherein the ceramic combination is in the form of a thin film and a cathode material is positioned in contact with one side of the thin film.

32. The method of claim 31, wherein an alkali metal electrolyte is present in at least a part of the porous thin film.

33. The method of claim 32, wherein an anode material is positioned in contact with said thin film on the other side of the cathode material.

34. The method of claim 32, wherein the cathode material includes a compound of one or more of Fe, Co, Cu and Ni, the thin film contains fibers of Al₂O₃ and an electrolyte containing LiCl is present in the thin film amount in the range of from about 80% to about 95% by volume of the film, and the anode contains Li or a compound thereof.

35. The method of claim 34, wherein the anode material contains lithium.
